(19) United States
(12) Patent Application Publication
(10) Pub. No.: US 2025/0271576 A1
(43) Pub. Date: Aug. 28, 2025

(54) THREE-DIMENSIONAL (3D) OBJECT DETECTION AND LABELING USING MOTION CUES

(71) Applicant: NVIDIA Corporation, Santa Clara, CA (US)

(72) Inventors: Jenny Seidenschwarz, Munich (DE); Francesco Ferroni, London (GB); Aljosa Osep, Pittsburgh, PA (US); Laura Leal-Taixe, Florence (IT)

(73) Assignee: NVIDIA Corporation, Santa Clara, CA (US)

(21) Appl. No.: 19/047,806

(22) Filed: Feb. 7, 2025

Related U.S. Application Data
(60) Provisional application No. 63/558,829, filed on Feb. 28, 2024.

(30) Foreign Application Priority Data
Dec. 6, 2024 (IT) 102024000027861

(51) Int. Cl. G01S 17/89; G01S 17/08; G01S 17/58

(52) U.S. Cl. CPC G01S 17/89; G01S 17/08; G01S 17/58

(57) ABSTRACT

In various examples, systems and methods are described for performing 3D object detection based at least on motion cues. In some examples, systems can obtain data associated with a plurality of LiDAR scans. The systems can then determine a set of point trajectories for points that move from scan to scan over time using a message passing network (MPN) and identify points that are associated with given objects represented by the LiDAR scans. The points can then be annotated based at least on whether they are associated with static objects to train an object detector or similar models.

### CROSS-REFERENCE TO RELATED APPLICATIONS

This application claims the benefit of Italian Patent Application No. 102024000027861, filed Dec. 6, 2024, and claims the benefit of U.S. Provisional Patent Application No. 63/558,829, filed Feb. 8, 2024, the contents of both of which are hereby incorporated by reference in their entirety.

### BACKGROUND

Object detection can be performed based at least on 3D point clouds generated by light detection and ranging (LiDAR) sensors. For example, approaches to object detection based at least on 3D point clouds typically involve manually labeling points within such point clouds with pre-defined object classes, and training data-driven models using supervised learning techniques to classify similar points in subsequently-received point clouds. But this process is expensive and, importantly, does not scale well to rare classes. Attempts to automate the annotation process through the implementation of heuristic-based processing pipelines continue to show an inherent inability to improve in performance to be comparable with existing, manual labeling processes. As a result, models trained/updated using some data-driven models can experience issues when identifying and appropriately bounding objects, particularly objects of rare classes that are not well-represented in general training datasets.

### SUMMARY

Embodiments of the present disclosure relate to systems and methods for performing 3D object detection based at least on motion cues. More specifically, embodiments disclosed herein relate to systems and methods for performing 3D object detection based at least on motion cues of portions of objects as represented by 3D point clouds.

In contrast to conventional systems, such as those described above, the present disclosure describes improved techniques involving segmentation of clusters of points within point clouds for subsequent labeling. Specifically, some example techniques are described that involve receiving a sequence of LiDAR scans and updating/training a Message Passing Network (MPN) to group points based at least on their proximity, rate of speed, and/or motion pattern in a class-agnostic manner (as represented by their trajectories). Techniques described herein can involve determining a set of point trajectories of points in point clouds generated by LiDAR sensors from a sequence of LiDAR data (e.g., data representing successive point clouds captured during operation of a vehicle). In contrast to heuristic approaches, the present disclosure involves updating/training and implementing an MPN with an objective of grouping points in a class-agnostic manner. In addition to proximity, the techniques described herein can involve learning to group points based at least on the observation that what moves together belongs together, given some labeled instances of moving objects. This way, the systems described herein can determine association based at least on common movement (e.g., represented by trajectories) and can streamline at least portions of pseudo-labeling processes to alleviate the need for manual geometric clustering. The present disclosure describes techniques to identify motion patterns in unlabeled sequences and pseudo-label these at the per-point segmentation level. By extracting bounding boxes and inflating them to better match amodal ground truth bounding boxes, the systems can annotate points with pseudo-labels and subsequently update/train 3D detection networks. The presently-disclosed approach not only allows for improved classification performance as compared to heuristic-based processing pipelines based at least on density-based clustering, but also demonstrates that the presently-disclosed MPN performance improves with an increasing amount of data, while still remaining a general approach applicable to different classes and datasets.

The present disclosure describes systems that allow for class-agnostic, motion-based segmentation for pseudo-labeling in a data-driven manner (as opposed to manual annotation). This allows for the systems to process point clouds faster than would otherwise be possible. Further, the systems described herein improve on existing techniques as they allow for pseudo-labeling in a class-agnostic manner, as opposed to techniques that involve labeling based at least on predetermined object classes. This can reduce the chances of over- or under-segmentation of points and subsequent updating/training on over- or under-segmented data.

At least one aspect relates to one or more processors. The one or more processors can include one or more circuits. The one or more circuits can obtain data associated with a plurality of light detection and ranging (LiDAR) scans representing an environment. The plurality of LiDAR scans can form a sequence of LiDAR scans. The one or more circuits can determine a set of point trajectories for a set of points represented by the plurality of LiDAR scans based at least on the sequence of the LiDAR scans, where at least one point trajectory of the set of point trajectories is associated with movement of a point along a surface of an object relative to the environment. The one or more circuits can obtain (e.g., initialize) a graph representation representing the plurality of LiDAR scans, the graph representation including a plurality of nodes configured to communicate messages in accordance with a set of edges. At least one node of the plurality of nodes can correspond to respective points of the set of points represented by the plurality of LiDAR scans and connected to at least one other node by at least one edge of the set of edges. The one or more circuits can update the plurality of LiDAR scans by associating (e.g., tagging) one or more points of the set of points with the object based on at least one edge of the set of edges being classified as a positive edge or a negative edge.

In some implementations, the one or more circuits to obtain the graph representation can initialize the graph such that at least one node of the plurality of nodes is associated with one or more respective points of the set of points represented by the plurality of LiDAR scans and connected to at least one other node by at least one edge of the set of edges. The one or more circuits can cause one or more messages to be transmitted based at least on the graph. At least one message of the one or more messages can include data associated with at least one point trajectory associated with at least one point in the graph, and the one or more circuits can classify at least one edge of the set of edges as a positive edge or a negative edge based in part on the data associated with the at least one point trajectory received at least one node of the plurality of nodes.

In some aspects, the one or more circuits can determine that one or more points represented by plurality of LiDAR scans are associated with one or more static objects. The one or more circuits can update the data associated with at least a subset of the plurality of LiDAR scans by removing the one or more points that are associated with the one or more static objects from the plurality of LiDAR scans.

In some aspects, the one or more circuits to obtain the graph representation are to determine a set of distances based at least on a position of at least one point of the set of points relative to at least one other point of the set of points in the environment. The one or more circuits can determine at least one subset of distances that satisfy a distance threshold based at least on the set of distances and initialize the graph including the plurality of nodes configured to exchange the messages in accordance with the set of edges corresponding to the subset of distances that satisfy the distance threshold.

In some aspects, the one or more circuits to determine the set of point trajectories for the set of points represented by the plurality of LiDAR scans can determine the set of point trajectories based at least on one or more movement patterns of points along the surface of the object relative to the environment. The one or more circuits to determine the set of point trajectories for the set of points represented by the plurality of LiDAR scans can determine the set of point trajectories for the set of points based at least on rates of change in location of the points along the surface of the object relative to the environment. In some aspects, the one or more circuits can aggregate the plurality of nodes into a cluster based at least in part on at least one edge of the set of edges that are classified as positive edges.

In some aspects, the one or more circuits to aggregate the plurality of nodes can determine that at least one set of nodes are connected by edges that are classified as positive edges and that the positive edges form a continuous set of connections. The one or more circuits can extract a bounding box based at least on the cluster and the point trajectories corresponding to the points of the cluster. The bounding box can be fit to the points of the cluster based at least on a midpoint of the cluster and a heading of the cluster; the heading based at least on a mean trajectory associated with the point trajectories of the points of the cluster.

In some aspects, the one or more processors can be included in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for implementing one or more multi-modal language models; a system for hosting one or more real-time streaming applications; a system for performing light transport simulation; a system for performing collaborative content creation for 3D assets; or a system implemented at least partially using cloud computing resources.

At least one aspect relates to a system. The system can include one or more processors. The one or more processors can perform operations including: obtaining data associated with a plurality of light detection and ranging (LiDAR) scans representing an environment, the plurality of LiDAR scans forming a sequence of LiDAR scans and determining a set of point trajectories for a set of points represented by the plurality of LiDAR scans based at least on the sequence of the LiDAR scans. At least one point trajectory of the set of point trajectories can be associated with movement of a point along a surface of an object relative to the environment. The one or more processors can perform operations including initializing a graph including a plurality of nodes that are configured to communicate messages in accordance with a set of edges, at least one node of the plurality of nodes corresponding to respective points of the set of points represented by the plurality of LiDAR scans and connected to at least one other node by at least one edge of the set of edges. The one or more processors can perform operations including updating the plurality of LiDAR scans by tagging one or more points of the set of points as being associated with the object based at least on at least one edge of the set of edges being classified as positive edges or negative edges.

In some aspects, the one or more processors to initialize the graph can initialize the graph such that at least one node of the plurality of nodes corresponding to respective points of the set of points represented by the plurality of LiDAR scans and connected to at least one other node by at least one edge of the set of edges. The one or more processors can perform operations including causing one or more messages to be transmitted based at least on the graph. At least one message of the one or more messages can include data associated with at least one point trajectory associated with at least one point in the graph. The one or more processors can classify at least one edge of the set of edges as positive edges or negative edges based at least in part on the data associated with the at least one point trajectory received at least one node of the plurality of nodes.

In some aspects, the one or more processors can perform operations including determining that one or more points represented by plurality of LiDAR scans are associated with one or more static objects. The one or more processors can perform operations including updating the data associated with a plurality of LiDAR scans by removing the one or more points that are associated with the one or more static objects from the plurality of LiDAR scans.

In some aspects, the one or more processors to initialize the graph can determine a set of distances based at least on a position of at least one point of the set of points relative to at least one other point of the set of points in the environment. The one or more processors can determine at least one subset of distances that satisfy a distance threshold based at least on the set of distances. And the one or more processors can initialize the graph including the plurality of nodes configured to exchange the messages in accordance with the set of edges corresponding to the subset of distances that satisfy the distance threshold.

In some aspects, the one or more processors to determine the set of point trajectories for the set of points represented by the plurality of LiDAR scans can determine the set of point trajectories based at least on one or more movement patterns of points along the surface of the object relative to the environment. In some aspects, the one or more processors to determine the set of point trajectories for the set of points represented by the plurality of LiDAR scans can determine the set of point trajectories for the set of points based at least on rates of change in location of the points along the surface of the object relative to the environment. The one or more processors can perform the operation of aggregating the plurality of nodes into a cluster based at least in part on at least one edge of the set of edges that are classified as positive edges.

In some aspects, the system is included in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system implementing one or more multi-modal language models; a system for hosting one or more real-time streaming applications; a system for performing light transport simulation; a system for performing collaborative content creation for 3D assets; or a system implemented at least partially using cloud computing resources.

At least one aspect relates to a method. The method can include determining a set of point trajectories for a set of points represented by a plurality of LiDAR scans. At least one point trajectory of the set of point trajectories can be associated with movement of a point along a surface of an object relative to an environment. The method can include initializing a graph including a plurality of nodes that are configured to communicate messages in accordance with a set of edges, at least one node of the plurality of nodes corresponding to respective points of the set of points represented by the plurality of LiDAR scans and connected to at least one other node by at least one edge of the set of edges. The method can include updating the plurality of LiDAR scans by tagging one or more points of the set of points as being associated with the object based at least on at least one edge of the set of edges being classified as positive edges or negative edges.

### BRIEF DESCRIPTION OF THE DRAWINGS

The present systems and methods for performing 3D object detection based at least on motion cues are described in detail below with reference to the attached drawing figures, wherein:

FIG. 1 is an example environment involved in implementing techniques for performing 3D object detection based at least on motion cues, in accordance with some embodiments of the present disclosure;

FIG. 2 is a flow diagram of an example method for performing 3D object detection based at least on motion cues, in accordance with some embodiments of the present disclosure;

FIG. 3 is an example processing pipeline for performing 3D object detection based at least on motion cues, in accordance with some embodiments of the present disclosure;

FIG. 4A is an illustration of an example autonomous vehicle, in accordance with some embodiments of the present disclosure;

FIG. 4B is an example of camera locations and fields of view for the example autonomous vehicle of FIG. 4A, in accordance with some embodiments of the present disclosure;

FIG. 4C is a block diagram of an example system architecture for the example autonomous vehicle of FIG. 4A, in accordance with some embodiments of the present disclosure;

FIG. 4D is a system diagram for communication between cloud-based server(s) and the example autonomous vehicle of FIG. 4A, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

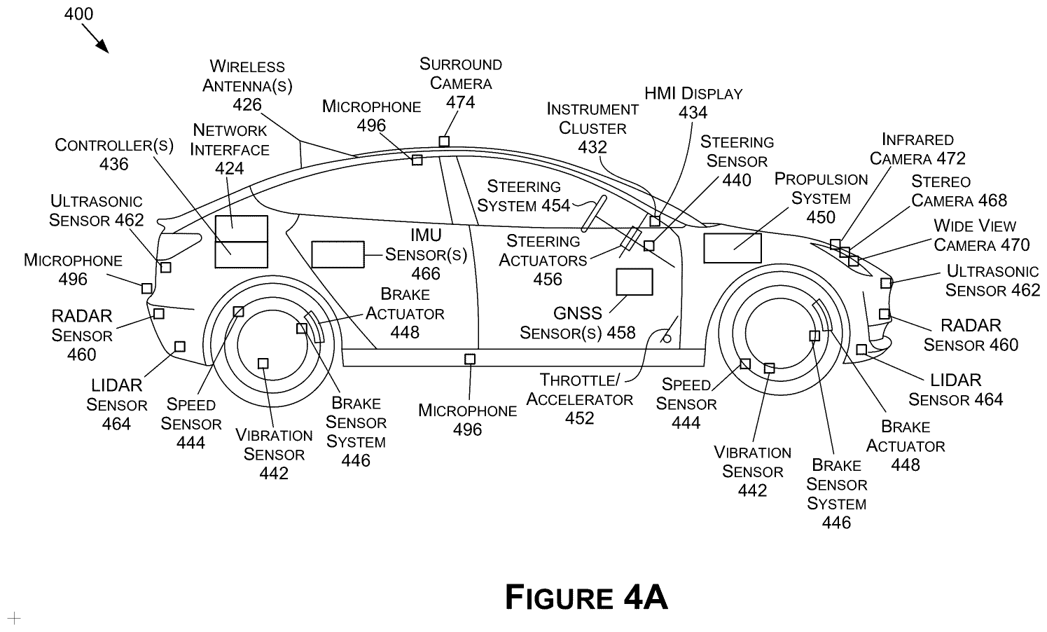

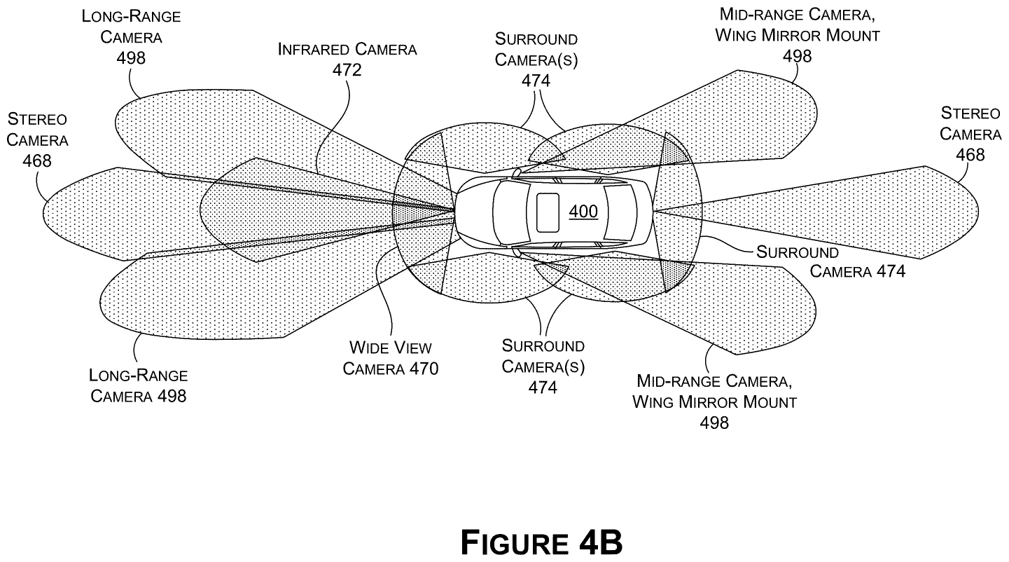

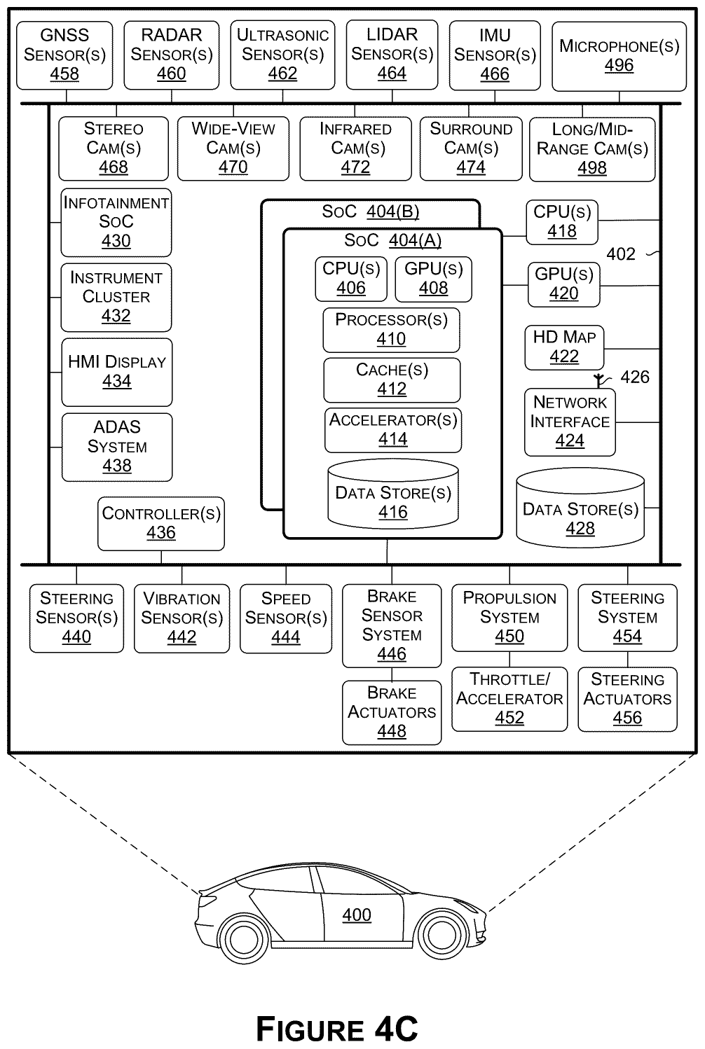

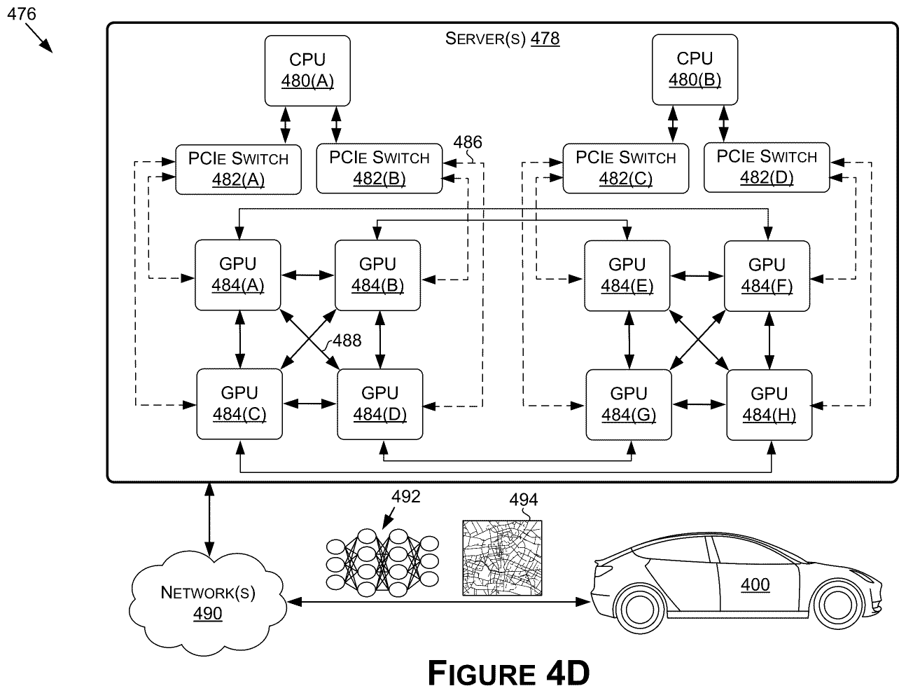

Systems and methods are disclosed related to systems and methods for performing 3D object detection based at least on motion cues. Although the present disclosure may be described with respect to an example autonomous vehicle 400 (alternatively referred to herein as “vehicle 400” or “ego-vehicle 400,” an example of which is described with respect to FIGS. 4A-4D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to object segmentation as related to point clouds generated by LiDAR sensors, this is not intended to be limiting, and the systems and methods described herein may be used in connection with any sensor capable of generating a three-dimensional, point-based representation of an environment of a vehicle, as well as in connection with augmented reality, virtual reality, mixed reality, robotics, security and surveillance, autonomous or semi-autonomous machine applications, and/or any other technology spaces where object segmentation may be used.

In some implementations, during updating/training, a system can initialize and implement a message passing network (MPN) that receives an initial set of trajectories for each point (e.g., determined based at least on the implementation of one or more object tracking techniques) corresponding to points in a point cloud and initializes a set of nodes corresponding to each point with the respective trajectories and edges connecting other nodes within a threshold distance. The system can then cause messages to be passed to update/train the MPN to mark the edges as either positive edges (e.g., connecting nodes that are moving in similar directions and/or rates of speed) or negative edges (e.g., connecting nodes that are not moving in similar directions and/or at similar rates of speed). The points can then be clustered and associated with a given object in the environment based at least on whether they are directly or indirectly connected to other points via positive edges and processed to determine, for example, one or more bounding boxes to be used when training/updating object detectors.

When implemented, the disclosed techniques provide improvements over existing 3D segmentation techniques that result in more accurate segmentation of points within point clouds. For example, the presently-disclosed techniques obviate or significantly reduce the need for manual review and annotation of points within point clouds during labeling (e.g., during pseudo-labeling). For example, the number of false positive pseudo-labels generated are reduced compared to implementations of conventional techniques. Further, by updating/training an MPN to segment points in accordance with their proximity to other points and their trajectories, the disclosed techniques allow for improved generalization when applied to situations involving objects that are rarely encountered (e.g., construction vehicles) as opposed to objects that are frequently encountered (e.g., vehicles, pedestrians, etc.). This allows for reduced over/under segmentation of objects in an environment due to the unavailability of training examples corresponding to edge cases. This also allows for improved segmentation of points that are close in proximity and moving in similar (but different) directions (e.g., two pedestrians walking next to one another).

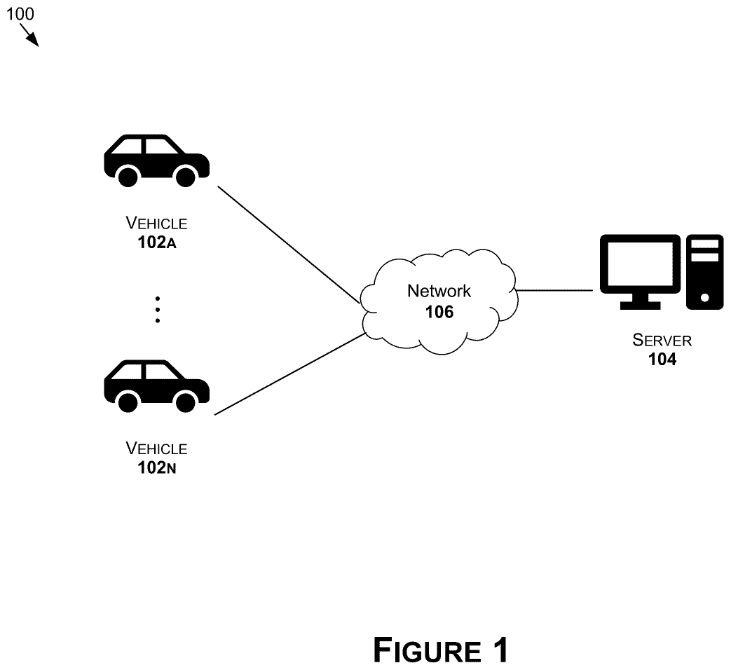

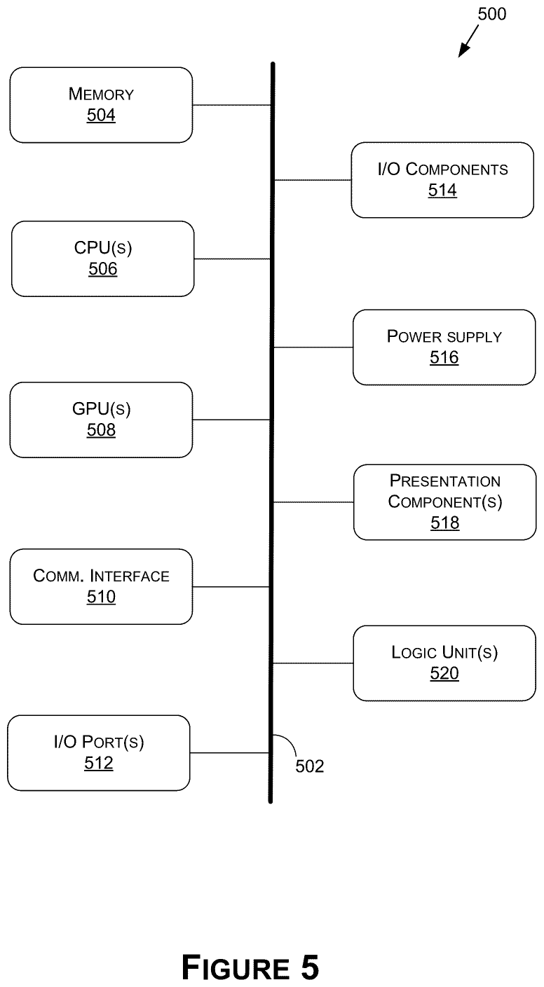

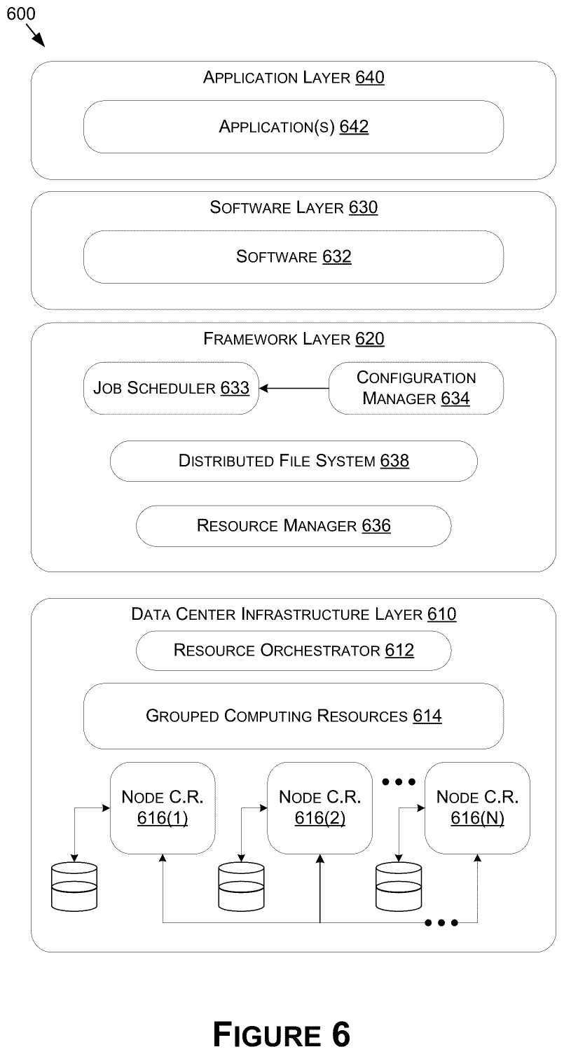

With reference to FIG. 1, FIG. 1 is an example environment 100 involved in implementing techniques for performing 3D object detection based at least on motion cues, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 400 of FIGS. 4A-4D, example computing device 500 of FIG. 5, and/or example data center 600 of FIG. 6.

The example environment 100 includes vehicles 102a-102n (referred to collectively as “vehicles 102” and individually as “vehicle 102” unless otherwise specified), a server 104, and a network 106. In some embodiments, the vehicles 102 and server 104 can interconnect (e.g., establish a connection to communicate and/or the like) via wired and/or wireless connections and/or via the network 106.

In some embodiments, the vehicles 102 can include one or more devices that are configured to be in communication with other vehicles 102 and/or the server 104. For example, the vehicles 102 can include a device such as a car, a truck, a delivery robot, a warehouse robot, and/or the like. In some embodiments, the vehicles 102 can include one or more components that are the same as, or similar to, the components of the example autonomous vehicle 400 as described herein. For example, the vehicles 102 can include one or more sensors (e.g., LiDAR sensors, RADAR sensors, cameras, and/or the like that are the same as, or similar to those described with respect to the example autonomous vehicle 400) that are disposed, supported by, and/or integrated on the vehicles 102. In some embodiments, the vehicles 102 can include one or more computing devices configured to process, store, and/or transmit the data generated by the one or more sensors during operation of the vehicles 102. For example, the vehicles 102 can include computing devices such as one or more SoCs (e.g., SoCs that are the same as, or similar to, the SoCs 404(A), (B) of FIG. 4C). In these examples, the computing devices can be configured to be in direct (e.g., wired) or indirect (e.g., wireless) communication with the one or more sensors of the vehicles 102 and can selectively or continuously process, store, and/or transmit the data generated by the sensors to the server 104. The computing devices of the vehicles 102 can also be configured to determine and execute one or more control signals to control operation (e.g., navigation, steering, acceleration, braking, and/or the like) of the vehicles 102 when operating within the environment. In some embodiments, the server can be associated with an autonomous vehicle developer.

In some embodiments, the server 104 can include one or more devices that are configured to be in communication with one or more of the vehicles 102. For example, the server 104 can be one or more devices such as a server computer, a desktop computer, and/or the like. In some embodiments, the server 104 can be configured to periodically or continuously receive data from the computing devices of the vehicles 102. For example, the server 104 can be configured to receive data generated by the sensors of the vehicles 102 and/or the data generated by the computing devices of the vehicles 102 and store the data in memory of the server 104. In some embodiments, the server can be associated with an automated vehicle developer or developers that support automated vehicle development.

In some embodiments, the network 106 can include one or more devices that allow for one or more wired and/or wireless networks. For example, the network 106 can include one or more components of a network environment, a network interface (e.g., that is the same as, or similar to, the network interface 424 of FIG. 4C), a communication interface (e.g., that is the same as, or similar to, the communication interface 510 of FIG. 5), and/or the like.

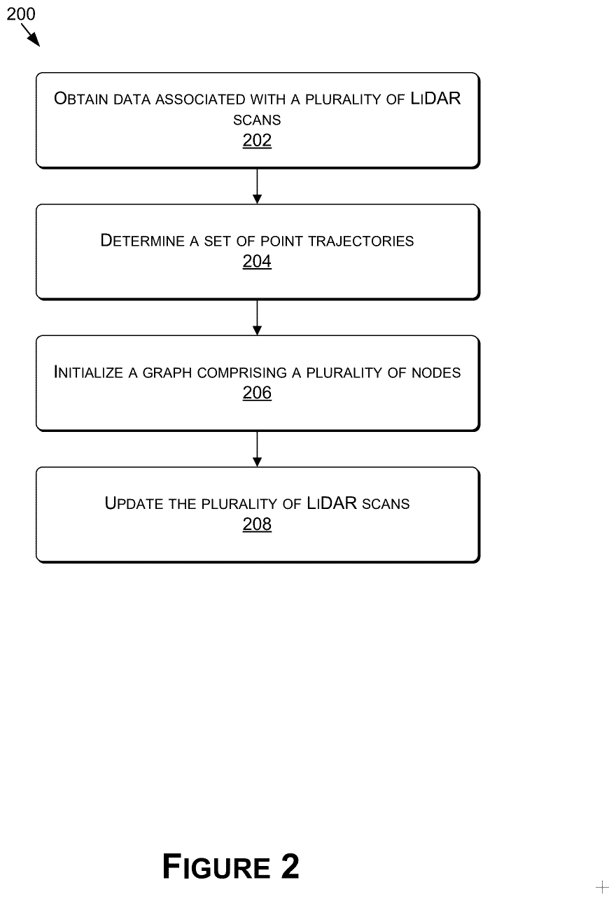

Now referring to FIG. 2, each block of method 200, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 200 is described, by way of example, with respect to the vehicles 102 and server 104 of FIG. 1. However, these methods may additionally or alternatively be executed by any one system, or any combination of systems, including, but not limited to, those described herein.

FIG. 2 is a flow diagram showing a method 200 for performing 3D object detection based at least on motion cues, in accordance with some embodiments of the present disclosure. The method 200, block 202 includes obtaining data associated with a plurality of LiDAR scans. For example, a server (e.g., that is the same as, or similar to, the server 104 of FIG. 1) can obtain the data associated with the plurality of LiDAR scans. In some embodiments, the server can obtain the data associated with the plurality of LiDAR scans from one or more vehicles (e.g., that are the same as, or similar to, the vehicles 102 of FIG. 1). For example, the server can obtain the data associated with the plurality of LiDAR scans from the one or more vehicles based at least on operation of the one or more vehicles through an environment. In some examples, the one or more vehicles can operate on one or more drivable surfaces such as roadways, parking lots, and/or the like. In examples, the one or more vehicles can operate on drivable surfaces such as warehouse floors, shipyard docks, and/or the like. While certain concepts are described herein with respect to the use of LiDAR sensors and generation of corresponding point clouds, it will be understood that any suitable distance sensor (e.g., RADAR sensors, cameras (e.g., stereoscopic cameras), and/or the like) can be implemented to obtain sensor data to allow the components described herein to generate and process the point clouds as described.

In some embodiments, the plurality of LiDAR scans can represent one or more portions of point clouds. For example, the plurality of LiDAR scans can include LiDAR scans from one or more LiDAR sensors installed on the vehicles. In some embodiments, a computing device of the vehicle or the server can fuse (e.g., join, combine) the plurality of LiDAR scans for each corresponding point in time at which the scans were generated. For example, the plurality of LiDAR scans can be aligned (e.g., based at least on a registration process aligning the fields of view of the LiDAR sensors with one another). In some embodiments, the one or more points of at least one (e.g., each) LiDAR scan can correspond to points along surfaces of objects in the environment in which the vehicles are operating. For example, the one or more points of each LiDAR scan can correspond to points along surfaces of objects in the environment that are within a sensing range of the LiDAR sensors.

In some embodiments, the plurality of LiDAR scans can form a sequence of LiDAR scans. For example, as the vehicles operate within their environment, the plurality of LiDAR scans can be generated and/or sampled at a frequency (e.g., 5 hz, 10 hz, 20 hz, and/or the like). The plurality of LiDAR scans can then be captured in order, forming the sequence. In this way, the LiDAR sensors can generate sequences of LiDAR scans representing operation of the vehicles within the environment over periods of time.

In the method 200, block 204 includes determining a set of point trajectories. For example, the server can determine the set of point trajectories based at least on the LiDAR scans obtained from the vehicles. In some embodiments, the set of point trajectories can be determined for a subset of the LiDAR scans received by the server. For example, the server can receive a set of LiDAR scans involved in operation of one or more vehicles, and the server can select and determine a subset of point trajectories corresponding to a subset of the LiDAR scans.

In some embodiments, at least one (e.g., each) point trajectory of the set of point trajectories can be associated with (e.g., indicate) movement of a point along a surface of an object as the object moves relative to a vehicle. For example, as a vehicle drives down a drivable surface (e.g., a lane of a road) the sensors of the vehicle can generate successive LiDAR scans including (or that can be used to form) point clouds, using the LiDAR sensors installed on the vehicle. In this example, the points corresponding to objects moving relative to the vehicle (e.g., because of movement by the object and/or movement by the vehicle) in each successive point cloud can represent the relative movement of points along the surfaces of the objects and/or relative to the environment. For example, each point can be associated with a corresponding point in each successive point cloud as the object moves within the field of view of the LiDAR sensors.

In some embodiments, the server can determine a set of point trajectories based at least on one or more movement patterns (e.g., characteristics, metrics, trends, vectors) of points along the surface of objects represented by the point cloud. For example, the server can determine a set of point trajectories based at least on one or more movement patterns of points along the surface of objects relative to the environment. In some embodiments, the server can determine the one or more movement patterns based at least on changes in location of the points along the surface of the object represented by successive point clouds. For example, as a first vehicle drives past a second vehicle generating point clouds using LiDAR sensors installed on the second vehicle, a location of the point in 3D space can change in location based at least on the movement of the first vehicle relative to the LiDAR sensors on the second vehicle. In this example, the server can determine the changes in location based at least on a difference in location for the point from point cloud to point cloud. As will be understood, in some examples the server can account for movement of the second vehicle by obtaining data associated with a speed and/or location of the vehicle from one or more sensors of the vehicle and updating the determined changes in location based at least on the speed and/or location of the second vehicle when each point cloud was generated. In some embodiments, the server can determine the one or more movement patterns based at least on changes in rates of change in the location of the points. For example, as the first vehicle drives past the second vehicle generating the point clouds, the distance measured between successive points representing a portion of surface of an object can change, representing a speed with which the first vehicle is moving. In this example, the server can determine a rate of change (e.g., a speed) based at least on the distances measured and a frequency at which the LiDAR sensor is configured to generate point clouds. The server can then determine the one or more movement patterns based at least on the rate of change of location of the points from point cloud to point cloud. Similar to above, the server can account for movement of the second vehicle by obtaining data associated with a speed and/or location of the vehicle from one or more sensors of the vehicle and updating the determined rates of change in location based at least on the speed and/or location of the second vehicle when each point cloud was generated.

In some embodiments, the server can determine that one or more points represented by the plurality of point clouds generated by the LiDAR sensor represent static objects or dynamic (e.g., not static) objects. For example, the server can determine that one or more points are associated with movement patterns that indicate the corresponding surface of the object the points represent is not moving within the environment. In this example, the server can determine that points associated with a velocity of zero (e.g., mailboxes, parked vehicles, and/or the like) or approximately zero (e.g., branches of trees moving smaller distances when compared to pedestrians walking or moving vehicles) correspond to static objects within the environment. In some embodiments, the server can then annotate each point as corresponding to a static object or a dynamic object and update the plurality of LiDAR scans based at least on the annotations. For example, the server can remove the one or more points that are associated with static objects from the plurality of LiDAR scans, leaving only the points corresponding to the dynamic objects within the environment.

In the method 200, block 206 includes initializing a graph comprising a plurality of nodes. For example, the server can initialize a graph comprising a plurality of nodes, where each node corresponds to a point or set of points represented by the plurality of point clouds. In some embodiments, the nodes can be associated with one or more edges between the nodes. For example, the serve can initialize the nodes of the graph where a set of edges connect each node of the plurality of nodes of the graph to one or more other nodes. In these examples, the plurality of nodes can correspond to respective points in at least one point cloud of the plurality of point clouds. In some embodiments, the server can initialize the graph such that each node of the plurality of nodes corresponding to respective points of one or more point clouds are connected based at least on a distance between the nodes and one or more other nodes. For example, the server can determine that a given node corresponds to a point within a point cloud that has one or more other points that are within a predetermined distance from that point. In this example, the server can then connect that node with the corresponding nodes of the points that are within the predetermined distance. In these examples, the server can further associate each node within the graph with the movement pattern for each corresponding point. In this way, the server can initialize the graph to allow for the nodes to communicate the motion patterns with other nodes when determining which points are associated with the same (or different) objects.

In some embodiments, the server can cause one or more messages to be transmitted between the nodes of the graph. For example, the server can cause each node to initially transmit messages indicating a point trajectory for respective points to one or more other nodes within the graph. The server can then cause each node to append one or more messages that were received (upon each iteration of transmission) and again transmit the messages indicating a point trajectory to one or more other nodes.

In some embodiments, the server can classify at least one (e.g., each) edge of the set of edges as positive edges or negative edges. For example, the server can classify an edge of the set of edges as a positive edge or a negative edge based at least on the data associated with the at least one point trajectory obtained by each node. The server can classify each edge as a positive edge or a negative edge based at least on comparing the at least one point trajectory that initially corresponds to a given node with the at least one point trajectory of different nodes as represented by the messages received by the given node.

As an example, a first node can receive two messages via two different edges to two different nodes. The first message can correspond to a first edge and can indicate that a second node corresponding to that edge is associated with a point trajectory that satisfies a threshold range. The threshold range can include an offset in location between trajectories that, when satisfied, indicates the points are moving in the same (or substantially the same) direction. In examples, the first message can additionally, or alternatively, indicate that the second node is moving at a rate of speed that satisfies a threshold speed. The threshold rate of speed can include an offset between rates of speed of the nodes that, when satisfied, indicates the points are moving at the same (or substantially the same) rate of speed. The server can then determine that the first node and the second node are associated with a positive edge and mark the edge between the two nodes as a positive edge.

As another example, the first node can receive a second message from a third node. The second message can correspond to the second edge (between the first node and the third node) and can indicate that the third node corresponding to that edge is associated with a point trajectory that does not satisfy a threshold range. The threshold range can include an offset in location between trajectories that, when satisfied, indicates the points are moving in the same (or substantially the same) direction. In examples, the first message can additionally, or alternatively, indicate that the third node is not moving at a rate of speed that satisfies a threshold speed. The threshold rate of speed can include an offset between rates of speed of the nodes that, when satisfied, indicates the points are moving at the same (or substantially the same) rate of speed. The server can then determine that the first node and the third node are associated with a negative edge and mark the edge between the two nodes as a positive edge.

The server can iteratively analyze the trajectories of nodes for which a given node has messages and determine whether the nodes are associated with the same object or different objects. For example, the server can similarly compare the direction or speed at which each point is moving based at least on the messages received by a given node and determine that the respective points are associated with trajectories that satisfy or do not satisfy the above-noted threshold range and/or threshold speed. Where points are identified as satisfying the threshold range and/or threshold speed, the server can identify the nodes as corresponding to the same object. As will be further understood, this process can be iteratively performed for each successively-analyzed point cloud and the server can update points within the point clouds as being associated with a given object or not associated with a given object. In this way, the server can update/train an MPN by causing the MPN to perform a series of message passing steps, where each node aggregates messages from its neighboring nodes and updates its feature vector accordingly. The updated feature vectors corresponding to the messages received at each node can then be used to make predictions, and the loss between the predicted values and the true labels can be determined. Loss functions for MPNs can include cross-entropy loss for classification tasks and mean squared error for regression tasks. The gradients of the loss with respect to the MPN's weights and biases can be computed using backpropagation and the weights and biases of the MPN can be updated using an optimization algorithm such as stochastic gradient descent. This process can be iteratively performed until the MPN converges.

In the method 200, block 208 includes updating the plurality of LiDAR scans. For example, the server can update the plurality of LiDAR scans by tagging the one or more points of the set of points as being associated with an object based at least on the positive edges associated with each point. In some embodiments, the server can then aggregate the plurality of nodes into one or more clusters. For example, the server can aggregate the plurality of nodes associated with positive edges into the corresponding clusters, where each cluster represents an object moving through the environment. In some embodiments, each node within a cluster can be associated with one or more positive edges and form a continuous set of connections therebetween.

In some embodiments, the server can extract one or more bounding boxes based at least on the clusters. For example, the server can extract the one or more bounding boxes based at least on the clusters and the point trajectories corresponding to the point cluster. In an example, the server can determine an average rate of speed and/or an average direction of movement for the object in three-dimensional space and extract a bounding box aligned with the rate of speed and/or direction. The server can then fit the bounding box to the points of the cluster. For example, the server can fit the bounding box to the points of the cluster based at least on a midpoint of the cluster and a heading represented by the average rate of speed and/or the average direction.

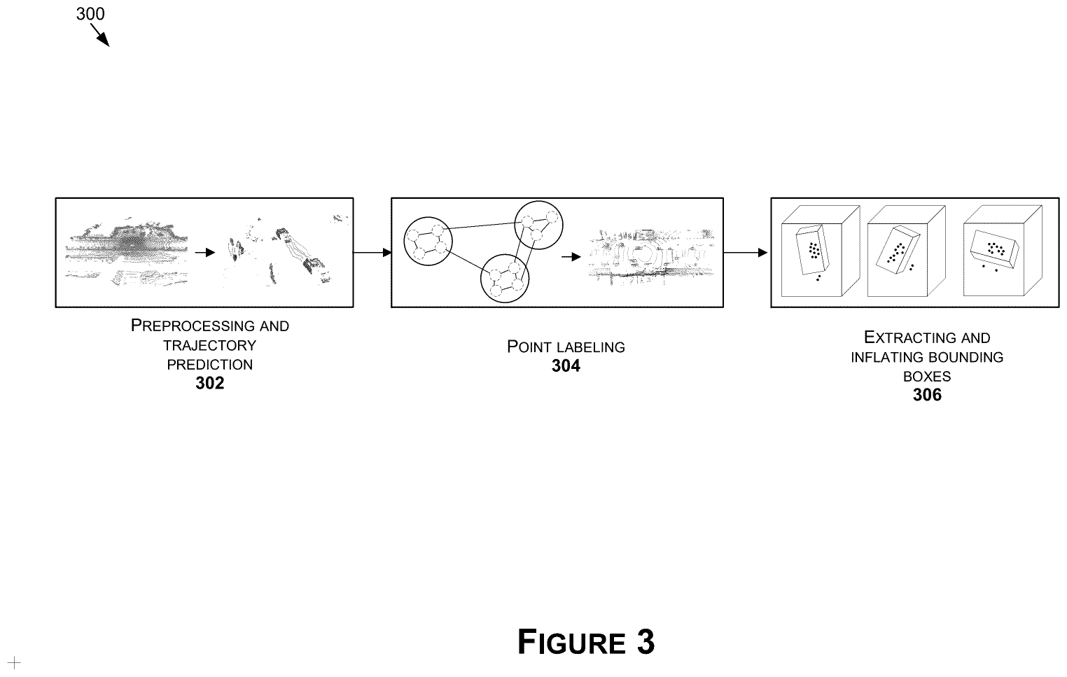

Now referring to FIG. 3, each block of the process 300 represented by the illustrated processing pipeline, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. In addition, method 300 is described, by way of example, with respect to the vehicles 102 and server 104 of FIG. 1. However, these methods may additionally or alternatively be executed by any one system, or any combination of systems, including, but not limited to, those described herein.

FIG. 3 is a flow diagram showing a process 300 for performing 3D object detection based at least on motion cues, in accordance with some embodiments of the present disclosure. In some embodiments, a server that is the same as, or similar to, the server 104 of FIG. 1 can implement one or more of the operations described herein. The one or more operations can be executed based at least on one or more point clouds generated by LiDAR sensors as described herein.

In some embodiments, the process 300, at block 302, includes preprocessing one or more point clouds. For example, given an input point clouds P generated by one or more LiDAR sensors, a model can be updated/trained to localize individual moving objects and extract corresponding 3D bounding boxes. Each object can be represented by an a priori unknown number of points in the respective point clouds, which a server implementing the model can group together. For example, the server can identify groupings of points based at least on proximity with nearby points likely belong to the same object when compared to farther points within a given point cloud, and similarities in motion patterns.

In some embodiments, the server can segment the point clouds into a set of instances by implementing correlation clustering techniques. In examples, the point cloud can be represented as a weighted graph G=(V, E) with nodes V and edges E. A node nᵢ represents a point and encodes its spatial position and motion as node features hᵢ⁽⁰⁾ while an edge e_{i,j} represents the geometrical connection between two points i and j with edge features hᵢⱼ⁽⁰⁾ representing their relationships. The clustering algorithm then cuts edges to obtain a set of connected components which represent point cloud instance segmentations. In some embodiments, node and edge features can then be processed in a data-driven manner to learn edge scores given some labeled data.

In some embodiments, the server can implement an MPN to propagate information across a graph and ensure that the learned graph partitioning does not only rely on the local relationships between points. Initial node hᵢ⁽⁰⁾ and edge features h_{i,j}⁽⁰⁾ are updated in an iterative manner over L layers. This ensures that the final edge features h_{i,j}^{(L)} contains global information, providing the necessary context needed to decompose the graph into object instances. In some embodiments, a binary edge classifier on top of h_{i,j}^{(L)} can be used to obtain edge scores.

In some embodiments, the server can receive a plurality of LiDAR scans corresponding to a LiDAR point cloud sequence [symbol] ={P^{t}∈ [symbol] ^{N}^{^{t}}^{×3}}, t∈1, . . . , T. The server can remove static points from the raw point clouds in P^{t}. As a result, the point clouds P^{t} can be updated to include a sequence of stationary point clouds [symbol] ={ [symbol] ^{t}∈ [symbol] ^{M}^{^{t}}^{×3}}, t∈1, . . . , T, where M^{t}≤N^{t}. For simplicity, the index t in omitted for clarity herein.

For each filtered point cloud [symbol] the server can predict ego-motion compensated point trajectories [symbol] ∈ [symbol] ^{M×(3×24)} using a self-supervised trajectory prediction network. Each point trajectory τᵢ∈ [symbol] can be identified as a sequence of point positions τᵢ={pᵢ^{k}}ₖ₌₀²⁴. The server can then use trajectory information to encode motion cues into graph features of the MPN, as described below. For each filtered point cloud [symbol] , the server can view points as nodes in a graph with corresponding node features. The node feature hᵢ⁽⁰⁾ can include (e.g., represent) spatial coordinates (x, y, z) and statistical measures (mean, min, max) of the velocities along its trajectory: hᵢ⁽⁰⁾=( [symbol] ᵢ, [symbol] ᵢ, [symbol] ᵢ, mean( [symbol] ), min( [symbol] ), max( [symbol] )). These features can capture both the spatial position and the dynamic behavior of each point. The server can then calculate the velocity at each time step as a difference between consecutive points in the trajectory: [symbol] ={pᵢ^{k+1}−pᵢ^{k}}ₖ₌₀^{k=24}.

In some embodiments, the server can connect nodes nᵢ∈V with edges e_{i,j} that hypothesize point-to-instance memberships. The server can leverage proximity between points to constrain node connectivity to a set of k-nearest neighboring nodes in terms of Euclidean distance. The edges eᵢⱼ can then be parameterized by connecting nodes i and j via initial edge features as the difference in their spatial coordinates: hᵢⱼ⁽⁰⁾=( [symbol] ᵢ- [symbol] ⱼ, [symbol] ᵢ- [symbol] ⱼ, [symbol] ᵢ- [symbol] ⱼ). This parameterization can capture the relative spatial relationship between the points in the point cloud. To ensure each edge obtains a global view of the point cloud, as needed for reliable clustering, several message passing iterations can be performed.

In some embodiments, the process 300, at block 304, includes extracting velocity-based features from trajectories to segment points based at least on motion patterns using a message passing network (MPN). For example, the server can cause an MPN to iteratively update node and edge embeddings. These updates can be caused for a fixed number of iterations L. In some embodiments, at each step l∈{1, . . . , L}, the server can update the embedding of an edge eᵢⱼ connecting nodes i and j based at least on its previous embedding hᵢⱼ^{(l-1)} and the embeddings of the adjacent nodes hᵢ^{(l-1)}, hⱼ^{(l-1)}:hᵢⱼ^{(l)}=ƒ(hᵢⱼ^{(l-1)},−hᵢ^{(l-1)},hⱼ^{(l-1)}), where ƒ(⋅, ⋅, ⋅) is a shared-weight update function, that consists of a linear, a normalization, and a dropout layer. In some embodiments, the server can update node embeddings based at least on their previous embeddings as well as their neighbors previous embeddings m_{i,j}^{(l)}=g(hᵢⱼ^{(l)},−hⱼ^{(l-1)},hᵢ^{(l-1)}),hᵢ^{(l)}=Ø({m_{i,j}^{(l)}}j∈Nᵢ), where g(⋅, ⋅) is the node update function with shared weights over all layers that constitutes of a linear layer, a normalization layer, and a dropout layer, φ is a mean aggregation function and Nᵢ denotes the set of nodes adjacent to node i. The iterative process of updating node and edge embeddings can allow for the integration of local and global information in the graph, enabling the algorithm to capture complex patterns and relationships within the data.

In some embodiments, the server can determine a final edge score by providing the final edge features hᵢⱼ^{(L)} through a final linear layer f_{f} followed by a sigmoid layer σ: \tilde{h}ᵢⱼ^{(L)}=σ(f_{f}(hᵢⱼ^{(L)})).

During inference, the server can first cut negative edges with score \tilde{h}ᵢⱼ^{(L)}<0.5. To ensure robustness towards a small set of possibly miss-classified outlier edges, the server can apply correlation clustering using the learned edge scores on top of this graph. The server can then discard all singleton nodes without edges. The resulting point clusters c_{c}∈C_{c} can represent segmented object instances as represented in the corresponding point clouds.

In some embodiments, the process 300, at block 306, includes obtaining pseudo-labels that can be used to train object detectors. For example, the server can train/update a student network (e.g., the object detector) by transforming a segmented point cluster c_{c} to a bounding box b_{c}. The server can then enhance the bounding box by inflation to obtain pseudo-labels as described herein.

In some embodiments, given a set of points that constitutes a point cluster c^{c}∈C_{c}, the server can determine a translation vector t_{c} by taking the midpoint of all points. Since each point i has a trajectory τᵢ assigned to it, the server can compute the mean trajectory \hat{τ}_{c}={\hat{p}_{c}^{k}}ₖ₌₀²⁴ and leverage \hat{p}_{c}¹ and \hat{p}_{c}² to determine the heading of the object in xy-direction α_{c}. With the heading α_{c} and the translation vector t_{c} the server can transform the points to determine axis-aligned length, width, and height of the bounding box lwh_{c} which yields the 3D bounding box b_{c}=[t_{c}, lwh_{c}, α_{c}].

In some embodiments, the bounding boxes b_{c} can represent a compact enclosing axis-aligned cuboid. Because ground truth bounding boxes are represented by typically looser, amodal bounding boxes, to adapt b_{c} to the corresponding ground truth data, the server can inflate them to have a minimum length, width, and height of xₘᵢₙ, yₘᵢₙ, and zₘᵢₙ, respectively, to obtain final pseudo-labels. The server can then update/train an object detector (e.g., a two-stage object detector) in a class-agnostic setting using generated pseudo-labels. The server can use the object detector as well as hyperparameters settings and perform one or more operations. To account for objects of various sizes, the server can adapt anchor box generation with various size parameters. The server can then adapt the detection region to a planar 100×40 m field, centered at the vehicle that generated a given point cloud (also referred to as an ego vehicle). The server can use binary cross-entropy loss to update/train object classifiers (object, background).

In some embodiments, the performance of the MPN and subsequently-trained/updated object detector can be evaluated. For example, one or more ablation studies can be implemented. The datasets involved in evaluating the MPN and/or the object detector include autonomous driving datasets that rely on LiDAR data though other datasets can be used depending on the sensor modality involved in generating point clouds. The dataset can include pre-annotated labels as amodal 3D bounding boxes for pedestrian, vehicle and cyclist classes.

The MPN and corresponding the object detector trained using the output of the MPN can be evaluated in a 100×40 m rectangular region (e.g., a region of importance for autonomous vehicles), centered at the ego-vehicle. As pseudo-labels and updated/trained detectors do not provide fine-grained semantic information, the MPN and object detector can be evaluated in a class-agnostic setting. Object detectors can be evaluated on moving-only (e.g., dynamic) objects represented by the datasets as well as all labeled objects to see how well training instances mined from moving regions generalize to non-moving objects. Objects can be identified in the datasets where they are identified as being associated with a velocity that is larger than 1 m/s. And non-moving instances (e.g., static objects) can be identified as regions to be ignored for evaluation purposes. For per-class recall analysis labels can be compared to class-agnostic detections if they have any 3D IoU overlap with labeled boxes.

To evaluate pseudo-label generation, an F1 score can be determined, represented as the harmonic mean of precision and recall. This metric can be used to evaluate a set of predictions that are not ranked. As the output of this step is point cloud instance segmentation, the results can be reported using both the mask intersection-over-union (SegIoU) criterion as well as 3D bounding box IoU (3DIoU) criterion for quantifying true positives and false negatives. This can be important as it assesses how well labeled amodal bounding boxes can be received to use to update/train object detectors. For object detection, performance can be evaluated using the average precision metric that assumes as input a ranked set of object detections. 3D bounding box IoU can be used as an evaluation criterion. For pseudo-label generation as well as object detection, performance can be evaluated using localization thresholds of T≤{0.7, 0.4} with 0.7 and 0.4 being example thresholds.

Approaches for pseudo-labeling can include use of a certain percentage of labeled data to tune hyperparameters. For example, given some labeled data, the MPN can be updated/trained as described herein to localize moving objects in sequences of point clouds. Unlabeled sets of training data can then be pseudo-labeled by the MPN, and subsequently used to update/train a (student) object detector.

To update/train and validate (teacher) MPN and (student) object detector independently, a validation training set can be split into two separate training sets, referred to as val_pseudo for the validation set of the teacher network, and val_det for the validation of the student detection network. Similarly, a training dataset can be divided into a training set train_pseudo used to update/train the teacher network, which is then usable to pseudo-label a student training set train_pseudo. Pseudo-labels can be used to update/train the object detection network. Note that the dataset can be split along sequences, e.g., frames of the same sequence can be excluded from one or more training or validation datasets.

To study the amount of data utilized to update/train an MPN, varying-sized sub-sets for training the MPN and object detector networks (train_pseudo and train_det) can be sampled. As constructing a fully connected graph can be difficult, a k-nearest-neighbor (kNN) graph can be constructed based at least on distance and velocity as similarity measures.

As shown in Table 1 (below) combining velocity and position in node features significantly aids the learning process. Solely utilizing velocity can lower recall and slightly increases precision compared to position-based features, indicating an increased amount of rejected positive edge hypotheses due to possibly noisy velocity predictions. On the other hand, position in node features leads to a drop in precision and a slight drop in recall indicating that the presently-disclosed MPNs can have difficulty correctly classifying certain negative edges. Concatenating both, velocity enables the presently-disclosed MPNs to reject negative edges between points in close proximity if they do not move together and clusters points that move together.

TABLE 1
Ablation (SegIoU)

| | Pr | Re | F1 | Pr | Re | F1 |
|---|---|---|---|---|---|---|
| Method | 0.7 | 0.7 | 0.7 | 0.4 | 0.4 | 0.4 |
| Graph | | | | | | |
| Oracle Velocity kNN | 35.7 | 67.1 | 46.6 | 39.4 | 74.1 | 51.4 |
| Oracle Position kNN | 85.0 | 87.9 | 86.4 | 89.4 | 92.5 | 90.9 |
| Node f. | | | | | | |
| Velocity | 61.2 | 52.7 | 57.0 | 73.0 | 62.2 | 67.1 |
| Position | 57.6 | 61.7 | 59.6 | 65.2 | 69.9 | 67.5 |
| Velocity + Position | 69.4 | 58.0 | 63.2 | 77.9 | 65.1 | 70.9 |
| Edge f. | | | | | | |
| Velocity | 58.9 | 48.6 | 53.2 | 69.6 | 57.4 | 62.9 |
| Position | 69.4 | 58.0 | 63.2 | 77.9 | 65.1 | 70.9 |
| Velocity + Position | 68.2 | 57.1 | 62.2 | 77.8 | 65.1 | 70.9 |

Tight bounding boxes can be inflated to enclose point clusters to a minimum width, length, and height. The segmentation performance changes only insignificantly while the detection performance improves drastically. Points generated by the MPNs described herein cluster together correctly, but can generate bounding boxes that are significantly tighter around the objects.

| | 3DIoU | | | SegIoU | | |
|---|---|---|---|---|---|---|
| | Pr 0.4 | Re 0.4 | F1 0.4 | Pr 0.4 | Re 0.4 | F1 0.4 |
| Initial | 33.2 | 27.8 | 30.3 | 77.9 | 65.1 | 70.9 |
| Inflated | 59.1 | 48.3 | 53.1 | 80.9 | 66.2 | 72.8 |

The presently-disclosed MPN can then be compared to different variants of DBSCAN, augmented with scene flow (DBSCAN++), long-term trajectory information (DBSCAN++) and outlier filtering. At the top, results show using ground truth scene flow and trajectories, and below shows scene flow and motion trajectories. The presently-disclosed MPNs consistently perform favorably compared to all DBSCAN variants, when using perfect “oracle” motion cues, as well as when using the estimated (noisy) scene flow method.

| | Pr | Re | F1 | Pr | Re | F1 |
|---|---|---|---|---|---|---|
| Method | 0.7 | 0.7 | 0.7 | 0.4 | 0.4 | 0.4 |

Oracle pseudo-label quality
with ground truth flow/trajectories

| | | | | | | |
|---|---|---|---|---|---|---|
| DBSCAN++ | 20.8 | 19.1 | 19.9 | 70.7 | 64.9 | 67.7 |
| DBSCAN++ | 20.6 | 19.1 | 19.8 | 72.0 | 66.2 | 69.0 |
| Presently- | 24.7 | 23.1 | 23.9 | 76.0 | 71.2 | 73.5 |
| disclosed MPNs | | | | | | |

Pseudo-label quality with our
computed flow/trajectories

| | | | | | | |
|---|---|---|---|---|---|---|
| DBSCAN | 0.9 | 5.7 | 1.5 | 6.0 | 39.3 | 10.4 |
| DBSCAN | 1.5 | 5.8 | 2.4 | 9.9 | 38.9 | 15.8 |
| DBSCAN++ | 1.4 | 6.1 | 2.2 | 8.9 | 39.9 | 14.5 |
| DBSCAN++ | 1.6 | 6.2 | 2.5 | 10.2 | 40.3 | 16.2 |
| DBSCAN++ | 0.9 | 5.6 | 1.6 | 6.3 | 39.2 | 10.9 |
| Presently- | 9.0 | 8.2 | 9.1 | 52.6 | 48.3 | 50.4 |
| disclosed MPNs | | | | | | |
| Presently- | 10.1 | 8.2 | 9.1 | 59.0 | 48.3 | 53.1 |
| disclosed MPNs | | | | | | |
| Presently- | 9.0 | 8.9 | 9.0 | 56.7 | 55.7 | 56.1 |
| disclosed MPNs | | | | | | |
| Presently- | 8.8 | 9.1 | 9.0 | 56.9 | 68.4 | 57.6 |
| disclosed MPNs | | | | | | |

As in graph construction, L2 distance between position- and velocity-based features can be considered, as well as the concatenation of both. As shown in Table 1, adding velocity to or completely omitting position from edge features can affect performance. Therefore, position-based encoding can be used for edges. For class-wise evaluation, ground truth classes can be assigned to pseudo-labels that have any overlap ground truth. The % unmatched false positives (uFP), e.g., pseud-labels not matched to any ground truth box.

| | DBSCAN++ | | Presently-disclosed MPNs | |
|---|---|---|---|---|
| | 3DIoU | SegIoU | 3DIoU | SegIoU |
| | Re (Pr) 0.4 | Re (Pr) 0.4 | Re (Pr) 0.4 | Re (Pr) 0.4 |
| Vehicle | 36.7 | 70.1 | 54.5 | 76.9 |
| Pedestrian | 46.3 | 67.9 | 41.8 | 55.1 |
| Cyclist | 77.1 | 1.0 | 81.3 | 95.8 |
| Class-agnostic | 40.3 (10.2) | 66.6 (16.8) | 48.3 (59.1) | 66.2 (80.9) |

| | | |
|---|---|---|
| uFP | 72.0 | 14.5 |

Bounding boxes can then be inflated to a minimum ground truth width, and height and show the impact on the performance on evaluation datasets Table 2. While the performance based at least on SegIoU does not change significantly, evaluating the performance based at least on 3DIoU improves drastically. The presently-disclosed MPN segments points correctly, but can generate tighter bounding boxes compared to ground truth.

The presently-disclosed MPN and updated/trained object detectors can be compared to three baselines: DBSCAN, DBSCAN++, and its variant DBSCAN++ that utilizes (long-term) velocity-based motion feature for a fair comparison Indicates heuristic filtering based at least on bounding box dimensions.

Results are discussed in terms of 3DIoU, as the output of this step is used to update/train object detectors that assume amodal bounding boxes. Results are obtained with ground-truth motion information (oracle). In this setting, both DBSCAN (69.0@0.4 F1) and the presently-disclosed MPNs (73.5@0.4 F1) perform well. However, when utilizing, estimated motion information, all DBSCAN variants struggle with precision-even the variant with outlier removal is unable to surpass 16.2@0.4 F1. By contrast, presently-disclosed MPN can learn to filter noise and undergo a significantly less severe performance drop as compared to its motion oracle. Contemplated embodiments of the presently-disclosed MPN surpass 50@0.4 F1, out-performing DBSCAN in terms of precision and recall.

As can be seen, by contrast to DBSCAN, the presently-disclosed techniques can learn to utilize long-term motion cues, and performs favorably compared to the variant that relies on local motion estimates. Finally, the presently-disclosed MPN benefits from increased amounts of training data. Performance monotonically increases with expanding training set, finally reaching 57.6@0.4 F1. The presently-disclosed MPN can be updated/trained on 90% labeled data and evaluated as shown in Table 5 (below).

TABLE 5

| | DBSCAN++ | | Presently-disclosed MPNs | |
|---|---|---|---|---|
| | 3DIoU | SegIoU | 3DIoU | SegIoU |
| | Re (Pr) 0.4 | Re (Pr) 0.4 | Re (Pr) 0.4 | Re (Pr) 0.4 |
| Bicyclist | 41.7 | 86.4 | 56.3 | 86.4 |
| Box Truck | 5.0 | 57.1 | 0 | 44.5 |
| Bus | 0 | 32.0 | 0.4 | 39.3 |
| Large Vehicle | 6.9 | 30.1 | 17.1 | 44.4 |
| Motorcyclist | 89.5 | 89.5 | 100 | 100 |
| Pedestrian | 29.7 | 59.8 | 42.5 | 57.1 |
| Regular | 44.5 | 75.2 | 56.9 | 77.9 |
| Vehicle | | | | |
| Stroller | 0 | 0 | 0.5 | 0.5 |
| Truck | 0 | 97.1 | 4.4 | 94.1 |
| Vehicular | 3.5 | 14.0 | 0 | 14.0 |
| Trailer | | | | |
| Class-agnostic | 33.3 (7.5) | 59.3 (13.4) | 45.8 (40.1) | 65.2 (57.0) |

In Table 4 the per-class analysis (e.g., based at least on an oracle classifier) is described. While similar recall is observed among the presently-disclosed MPN and DBSCAN++, DBSCAN++ is shown to produce significantly more false positive pseudo-labels when compared to the presently-disclosed MPN, quantified via % uFP, the percentage of pseudo-labels not matched to any ground truth object. This demonstrates that the presently-disclosed MPN produces a pseudo-label set that has a significantly better signal-to-noise ratio.

The ability of cross-dataset generalization is evaluated in view of the presently-disclosed MPN. In Table 5 the presently-disclosed MPN again demonstrates consistent favorable performance when compared to the DBSCAN baseline.

Finally, the pseudo-labeled data generated by the presently-disclosed MPN is used to update/train an object detector. As a baseline, a control object detector is updated/trained with fine-grained semantic information (class-specific) as well as class-agnostic information. Further, the control object detector is updated/trained using all objects (stat.+mov), as well as moving-only (mov-only). Finally, the performance of the control detector is compared to a detector updated/trained using the output of the MPN as disclosed herein on all objects (see Table 6), as well as only on moving objects (Table 6). Results are also reported for mixing pseudo-labeled with 10% of labeled data by re-using the train_pseudo splits.

TABLE 6

| | % | % ground | Pr | Re | AP | mAP | Pr | Re | AP | mAP |
|---|---|---|---|---|---|---|---|---|---|---|
| | Pseudo | truth | 0.7 | 0.7 | 0.7 | 0.7 | 0.4 | 0.4 | 0.4 | 0.4 |
| All (Moving + | | | | | | | | | | |
| stationary) | | | | | | | | | | |
| Stat. + Mov., | 0 | 100 | 35.5 | 55.5 | — | 37.1 | 69.7 | 44.6 | — | 80.3 |
| class-specific | | | | | | | | | | |
| Stat. + Mov., | 0 | 100 | 31.8 | 41.2 | 36.1 | — | 51.2 | 66.5 | 64.7 | — |
| class-agnostic | | | | | | | | | | |
| Mov-only, class | 0 | 100 | 34.4 | 19.9 | 15.1 | — | 63.9 | 37.1 | 35.0 | — |
| agnostic | | | | | | | | | | |
| DBSCAN++ | 90 | 10 | 7.4 | 35.1 | 31.1 | — | 11.5 | 55.0 | 52.0 | — |
| DBSCAN++ | 100 | 0 | 0.8 | 3.4 | 0.8 | — | 5.9 | 25.9 | 14.9 | — |
| Presently- | 90 | 0 | 3.8 | 3.4 | 1.8 | — | 26.9 | 24.1 | 19.5 | — |
| disclosed MPN | | | | | | | | | | |
| Presently- | 90 | 10 | 25.4 | 35.4 | 31.8 | — | 40.7 | 56.8 | 54.6 | - |
| disclosed MPN | | | | | | | | | | |
| Moving only | | | | | | | | | | |
| Stat. + Mov., | 0 | 100 | 30.5 | 34.5 | — | 43.2 | 36.4 | 41.1 | — | 85.6 |
| class-specific | | | | | | | | | | |
| Stat. + Mov., | 0 | 100 | 16.1 | 52.8 | 44.8 | — | 28.1 | 92.4 | 88.7 | — |
| class-agnostic | | | | | | | | | | |
| Mov-only, class | 0 | 100 | 33.9 | 53.7 | 44.3 | — | 57.6 | 91.2 | 89.0 | — |
| agnostic | | | | | | | | | | |
| DBSCAN++ | 90 | 10 | 2.0 | 34.5 | 29.8 | — | 4.1 | 70.1 | 61.0 | — |
| DBSCAN++ | 100 | 0 | 5.9 | 9.7 | 2.4 | — | 3.6 | 58.6 | 43.2 | — |
| Presently- | 90 | 0 | 3.8 | 10.7 | 4.2 | — | 23.3 | 66.0 | 57.5 | — |
| disclosed MPN | | | | | | | | | | |
| Presently- | 90 | 10 | 9.4 | 35.4 | 31.7 | — | 19.7 | 74.6 | 66.2 | — |
| disclosed MPN | | | | | | | | | | |
| DBSCAN++ | 100 | 0 | — | — | — | — | — | — | — | 40.4 |

TABLE 7
The control object detector is updated/trained
on ground truth data as well as on pseudo labels
generated with the presently-disclosed MPN.

| | P % | L % | Pr 0.4 | Re 0.4 | AP 0.4 |
|---|---|---|---|---|---|
| All | | | | | |
| Labeled | 0 | 100 | 52.3 | 39.3 | 35.5 |
| Presently-disclosed MPN | 100 | 0 | 12.2 | 30.7 | 22.9 |
| Moving | | | | | |
| Labeled | 0 | 100 | 45.1 | 85.5 | 82.4 |
| Presently-disclosed MPN | 100 | 0 | 8.0 | 64.7 | 57.6 |

In Table 6 (top) results are shown for all static and moving objects As can be seen, with the control object detector, an 80.3 mAP is obtained. In the class agnostic setting, the control object detector obtains 64.7 AP, which drops to 35 AP when only updating/training with ground truth boxes labeled as moving. When using 10% of ground truth labels, results of 52.0 and 54.8 AP are obtained with DBSCAN and the presently-disclosed MPN, respectively. Remarkably, when utilizing any pseudo-labels in conjunction with 10% labeled data, higher AP is obtained compared to the variant, updated/trained with moving-only ground truth labels. This is likely because due to the noisy estimated flow, some static objects are retained. The moving-only ground truth version learns to only predict objects in regions where moving objects are likely to appear. Additionally, pseudo-labels may induce generalization to the updating/training process. When not utilizing any labeled data, we obtain 14.9 and 19.5 AP, respectively. With the presently-disclosed MPN, 56.6% of the performance of the variant is recovered, updated/trained on ground truth moving-only labels.

When analyzing the performance on moving objects only in Table 6 (bottom), models, updated/trained on pseudo-labeled bounding boxes, are significantly closer to fully supervised models (88.7 updated/trained on all data, and 89.0 when updated/trained with moving only). Utilizing no labeled data, DBSCAN reaches 43.2 (48% of ground truth model), while the presently-disclosed MPN reaches 57.5 (64% of ground truth model). When using 10% of labeled data, the presently-disclosed MPN reaches 66.2 AP (64% of ground truth model).

Finally, in Table 7 results are obtained by updating/training the control object detector on a second dataset. The control object detector (labeled) is compared to the object detector updated/trained based at least on the output of the presently-disclosed MPN, updated/trained via pseudo-labels, generated on the second dataset. Importantly, pseudo-labels are generated using the presently-disclosed MPN updated/trained on a different dataset, thus truly assessing cross-dataset generalization. When reporting results on all objects, the control object detector obtained 35.5 AP with the supervised model, and 22.9 with the object detector that is based at least on the output of the presently-disclosed MPN. For moving objects, 82.9 is obtained with the control object detector, and 57.6 with the object detector that is based at least on the output of the presently-disclosed MPN, confirming that the MPN is indeed general and transferable across datasets.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model updating/training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LiDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the High Definition (“HD”) map 422 of FIG. 4C), location data (e.g., the vehicle's 400 location, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424 which may use one or more wireless antenna(s) 426 and/or modem(s) to communicate over one or more networks. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may be any number (including zero) of wide-view cameras 470 on the vehicle 400. In addition, any number of long-range camera(s) 498 (e.g., a long-view stereo camera pair) may be used for depth-based object detection, especially for objects for which a neural network has not yet been updated/trained. The long-range camera(s) 498 may also be used for object detection and classification, as well as basic object tracking.

Any number of stereo cameras 468 may also be included in a front-facing configuration. In at least one embodiment, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360 degree camera(s), and/or the like. Four example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C are illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400, and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LiDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 412 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high-dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LiDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surroundings at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 460 m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LiDAR sensor(s) 464. The LiDAR sensor(s) 464 may be used for object and pedestrian detection, emergency braking, collision avoidance, and/or other functions. The LiDAR sensor(s) 464 may be functional safety level ASIL B. In some examples, the vehicle 400 may include multiple LiDAR sensors 464 (e.g., two, four, six, etc.) that may use Ethernet (e.g., to provide data to a Gigabit Ethernet switch).

In some examples, the LiDAR sensor(s) 464 may be capable of providing a list of objects and their distances for a 360-degree field of view. Commercially available LiDAR sensor(s) 464 may have an advertised range of approximately 400 m, with an accuracy of 2 cm-3 cm, and with support for a 400 Mbps Ethernet connection, for example. In some examples, one or more non-protruding LiDAR sensors 464 may be used. In such examples, the LiDAR sensor(s) 464 may be implemented as a small device that may be embedded into the front, rear, sides, and/or corners of the vehicle 400. The LiDAR sensor(s) 464, in such examples, may provide up to a 120-degree horizontal and 35-degree vertical field-of-view, with a 200 m range even for low-reflectivity objects. Front-mounted LiDAR sensor(s) 464 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 400. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LiDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 400), while the I2V communication concept provides information about traffic further ahead. CACC systems may include either or both I2V and V2V information sources. Given the information of the vehicles ahead of the vehicle 400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network which is trained and thus reduces the risk of false positives, as described herein.

The vehicle 400 may further include the infotainment SoC 430 (e.g., an in-vehicle infotainment system (IVI)). Although illustrated and described as a SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 400. For example, the infotainment SoC 430 may radios, disk players, navigation systems, video players, USB and Bluetooth connectivity, carputers, in-car entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road-work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 633, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 633 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 633. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain data associated with a plurality of light detection and ranging (LiDAR) scans representing an environment, the plurality of LiDAR scans forming a sequence of LiDAR scans;
determine a set of point trajectories for a set of points represented by the plurality of LiDAR scans based at least on the sequence of the LiDAR scans, at least one point trajectory of the set of point trajectories associated with movement of a point along a surface of an object relative to the environment;
obtain a graph representation representing the plurality of LiDAR scans, the graph representation comprising a plurality of nodes configured to communicate messages in accordance with a set of edges, at least one node of the plurality of nodes corresponding to a respective point of the set of points represented by the plurality of LiDAR scans and connected to at least one other node by at least one edge of the set of edges; and
update the plurality of LiDAR scans by associating one or more points of the set of points with the object based on at least one edge of the set of edges being classified as a positive edge or a negative edge.

2. The one or more processors of claim 1, wherein to obtain the graph representation, the one or more circuits are to:
initialize the graph such that at least one node of the plurality of nodes is associated with one or more respective points of the set of points represented by the plurality of LiDAR scans and connected to at least one other node by at least one edge of the set of edges; and
wherein the one or more circuits are to:
cause one or more messages to be transmitted based at least on the graph, at least one message of the one or more messages comprising data associated with the at least one point trajectory associated with at least one point in the graph; and
classify at least one edge of the set of edges as a positive edge or a negative edge based at least in part on the data associated with the at least one point trajectory received by at least one node of the plurality of nodes.

3. The one or more processors of claim 1, wherein the one or more circuits are further to:
determine that one or more points represented by the plurality of LiDAR scans are associated with one or more static objects; and
update the data associated with at least a subset of the plurality of LiDAR scans by removing the one or more points that are associated with the one or more static objects from the plurality of LiDAR scans.

4. The one or more processors of claim 1, wherein, to obtain the graph representation, the one or more circuits are to:
determine a set of distances based at least on a position of at least one point of the set of points relative to each other point of the set of points in the environment;
determine at least one subset of distances that satisfy a distance threshold based at least on the set of distances; and
initialize the graph comprising the plurality of nodes configured to exchange the messages in accordance with the set of edges corresponding to the subset of distances that satisfy the distance threshold.

5. The one or more processors of claim 1, wherein to determine the set of point trajectories for the set of points represented by the plurality of LiDAR scans, the one or more circuits are to:
determine the set of point trajectories based at least on one or more movement patterns of points along the surface of the object relative to the environment.

6. The one or more processors of claim 4, wherein to determine the set of point trajectories for the set of points represented by the plurality of LiDAR scans, the one or more circuits are to:
determine the set of point trajectories for the set of points based at least on rates of change in location of the points along the surface of the object relative to the environment.

7. The one or more processors of claim 1, wherein the one or more circuits are further to aggregate the plurality of nodes into a cluster based at least in part on each edge of the set of edges being classified as a positive edge.

8. The one or more processors of claim 7, wherein to aggregate the plurality of nodes, the one or more circuits are to:
determine that at least one set of nodes of the plurality of nodes are connected by edges that are classified as positive edges and that the positive edges form a continuous set of connections.

9. The one or more processors of claim 7, wherein the one or more circuits are further to:
extract a bounding box based at least on the cluster and the point trajectories corresponding to the points of the cluster.

10. The one or more processors of claim 9, wherein to extract the bounding box, the one or more circuits are to:
fit the bounding box to the points of the cluster based at least on a midpoint of the cluster and a heading of the cluster, the heading based at least on a mean trajectory associated with the point trajectories of the points of the cluster.

11. The one or more processors of claim 1, wherein the one or more processors is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system implementing one or more multi-modal language models;
a system for hosting one or more real-time streaming applications;
a system for performing light transport simulation;
a system for performing collaborative content creation for 3D assets; or
a system implemented at least partially using cloud computing resources.

12. A system comprising:
one or more processors to perform operations comprising:
obtaining data associated with a plurality of light detection and ranging (LiDAR) scans representing an environment, the plurality of LiDAR scans forming a sequence of LiDAR scans;
determining a set of point trajectories for a set of points represented by the plurality of LiDAR scans based at least on the sequence of the LiDAR scans, at least one point trajectory of the set of point trajectories associated with movement of a point along a surface of an object relative to the environment;
initializing a graph comprising a plurality of nodes that are configured to communicate messages in accordance with a set of edges, at least one node of the plurality of nodes corresponding to respective points of the set of points represented by the plurality of LiDAR scans and connected to at least one other node by at least one edge of the set of edges; and
updating the plurality of LiDAR scans by tagging one or more points of the set of points as being associated with the object based at least on at least one edge of the set of edges being classified as a positive edge or a negative edge.

13. The system of claim 12, wherein to initialize the graph, the one or more processors are to:
initialize the graph such that each node of the plurality of nodes corresponds to respective points of the set of points represented by the plurality of LiDAR scans and is connected to at least one other node by at least one edge of the set of edges; and
wherein the one or more processors are to perform operations comprising:
causing one or more messages to be transmitted based at least on the graph, each message of the one or more messages comprising data associated with at least one point trajectory associated with at least one point in the graph; and
classifying each edge of the set of edges as positive edges or negative edges based at least in part on the data associated with the at least one point trajectory received at each node of the plurality of nodes.

14. The system of claim 12, wherein the one or more processors are to perform operations comprising:
determining that one or more points represented by the plurality of LiDAR scans are associated with one or more static objects; and
updating the data associated with the plurality of LiDAR scans by removing the one or more points that are associated with the one or more static objects from the plurality of LiDAR scans.

15. The system of claim 12, wherein to initialize the graph, the one or more processors are to:
determine a set of distances based at least on a position of each point of the set of points relative to each other point of the set of points in the environment;
determine at least one subset of distances that satisfy a distance threshold based at least on the set of distances; and
initialize the graph comprising the plurality of nodes configured to exchange the messages in accordance with the set of edges corresponding to the subset of distances that satisfy the distance threshold.

16. The system of claim 12, wherein to determine the set of point trajectories for the set of points represented by the plurality of LiDAR scans, the one or more processors are to:
determine the set of point trajectories based at least on one or more movement patterns of points along the surface of the object relative to the environment.

17. The system of claim 16, wherein to determine the set of point trajectories for the set of points represented by the plurality of LiDAR scans, the one or more processors are to:
determine the set of point trajectories for the set of points based at least on rates of change in location of the points along the surface of the object relative to the environment.

18. The system of claim 12, wherein the one or more processors are to perform the operation of: aggregating the plurality of nodes into a cluster based at least in part on each edge of the set of edges that are classified as positive edges.

19. The system of claim 12, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system implementing one or more multi-modal language models;
a system for hosting one or more real-time streaming applications;
a system for performing light transport simulation;
a system for performing collaborative content creation for 3D assets; or
a system implemented at least partially using cloud computing resources.

20. A method comprising:
determining a set of point trajectories for a set of points represented by a plurality of LiDAR scans, at least one point trajectory of the set of point trajectories being associated with movement of a point along a surface of an object relative to an environment;
initializing a graph comprising a plurality of nodes that are configured to communicate messages in accordance with a set of edges, at least one node of the plurality of nodes corresponding to respective points of the set of points represented by the plurality of LiDAR scans and connected to at least one other node by at least one edge of the set of edges; and
updating the plurality of LiDAR scans by associating one or more points of the set of points with the object based at least on each edge of the set of edges being classified as a positive edge or a negative edge.
